(19) United States
(12) Patent Application Publication
(10) Pub. No.: US 2019/0177616 A1
(43) Pub. Date: Jun. 13, 2019

(54) HYDROPHOSPHORYLATED POLYCARBOXYLIC ACIDS AND THEIR SYNERGISTIC COMBINATIONS AS CORROSION AND SCALE INHIBITORS

(71) Applicant: Ecolab USA Inc., St. Paul, MN (US)

(72) Inventors: Anand Harbindu, Pune (IN); Xiaodong Huang, Aurora, IL (US); Santanu Banerjee, Pune (IN); Atul Arun Dhavan, Pune (IN)

(73) Assignee: Ecolab USA Inc., St. Paul, MN (US)

(21) Appl. No.: 16/217,967

(22) Filed: Dec. 12, 2018

Related U.S. Application Data
(60) Provisional application No. 62/598,073, filed on Dec. 13, 2017.

(51) Int. Cl. C09K 15/32; C09K 15/06; C23F 11/12; C02F 5/14

(52) U.S. Cl. CPC C09K 15/32; C02F 5/14; C23F 11/126; C09K 15/06

(57) ABSTRACT

Inhibitors and methods for reducing or inhibiting corrosion and/or scale of metals in aqueous systems are provided. Inhibitor compositions may include a polymer and hydrophosphorylated polycarboxylic acids, such as 1-(hydroxyhydrophosphoryl)butane-1,2,3,4-tetracarboxylic acid. The compositions may include other components, such as zinc, molybdate, silicate, cerium, among others. The disclosed hydrophosphorylated polycarboxylic acids are stable in the presence of biocides.

### BACKGROUND

### 1. Field of the Invention

The present disclosure generally relates to corrosion inhibitors and scale inhibitors. More particularly, the disclosure pertains to corrosion inhibitor compositions and/or scale inhibitor compositions containing hydrophosphorylated polycarboxylic acids and methods of reducing or inhibiting corrosion of metallic surfaces in aqueous systems.

### 2. Description of the Related Art

Carbon steel corrosion inhibition has evolved over many decades from the use of chromate to the current heavy metals and phosphate chemistries. Several decades ago, chromate was banned and was predominantly replaced by molybdenum, zinc, silicate and phosphate. Several advances have been made in the phosphate chemistries from the use of orthophosphate to polyphosphate and the use of organic phosphates, phosphonates, and phosphinates. Currently, phosphorus is under environmental pressure and may only be used in very low-level quantities.

Ferrous metals, such as carbon steel, are among the most commonly used structural materials in industrial systems. Loss of the metals from surfaces resulting from general corrosion causes deterioration of the structural integrity of the system or structure because of reduction of mechanical strength. Localized corrosion (e.g. pitting) may pose an even greater threat to the normal operation of the system than general corrosion because such corrosion will occur intensely in one particular location and may cause perforations in the system structure carrying an industrial water stream. These perforations may cause leaks, which require shutdown of the entire industrial system so that repair can be made. Indeed, corrosion problems usually result in immense maintenance costs, as well as costs incurred because of equipment failure. Therefore, the inhibition of metal corrosion in industrial water is critical.

Corrosion protection of ferrous metals in industrial water systems is often achieved by adding a corrosion inhibitor. Many corrosion inhibitors, including chromate, molybdate, zinc, nitrite, orthophosphate, and polyphosphate have been used previously, alone or in combination, in various chemical treatment formulations. However, these inorganic chemicals can be toxic, detrimental to the environment, and/or not very effective against localized corrosion, especially at economically feasible and/or environmentally acceptable low dosage levels.

Corrosion has also been managed by using more corrosion resistant materials, applying protective coatings, and/or using sacrificial anode or chemical treatment. Since aqueous corrosion has been shown to consist of, for the most part, an electrochemical process, the chemical treatments have been applied as anodic inhibitors, cathodic inhibitors, or a combination of cathodic and anodic inhibitors.

### BRIEF SUMMARY

In some embodiments, a method of inhibiting corrosion and/or scale formation is disclosed. The method may include adding a composition to an aqueous medium, wherein the composition comprises a polymer and a compound of formula (I) or salt thereof,

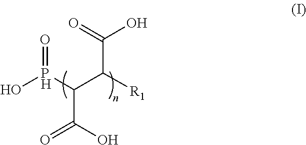

where R₁ is hydrogen, hydroxy, or a C₁-C₄ carboxyalkyl group; and n is 1, 2, 3, 4, or 5.

In some embodiments, R₁ is hydrogen.

In some embodiments, n is 2, 3, or 4.

In some embodiments, n is 2.

In some embodiments, the compound of formula (I) or salt thereof is selected from: 2-(hydroxyhydrophosphoryl)succinic acid; 1-(hydroxyhydrophosphoryl)butane-1,2,3,4-tetracarboxylic acid; 1-(hydroxyhydrophosphoryl)hexane-1,2,3,4,5,6-hexacarboxylic acid; 1-(hydroxyhydrophosphoryl)octan-1,2,3,4,5,6,7,8-octacarboxylic acid; 1-hydroxy-4-(hydroxyhydrophosphoryl)butane-1,2,3,4-tetracarboxylic acid; sodium 3,4,5,6-tetracarboxy-2-(carboxymethyl)-6-(hydroxyhydrophosphoryl)hexanoate; and any combination thereof.

In some embodiments, the compound of formula (I) or salt thereof is selected from: 1-(hydroxyhydrophosphoryl)butane-1,2,3,4-tetracarboxylic acid; 1-(hydroxyhydrophosphoryl)hexane-1,2,3,4,5,6-hexacarboxylic acid; 1-(hydroxyhydrophosphoryl)octan-1,2,3,4,5,6,7,8-octacarboxylic acid; and any combination thereof.

In some embodiments, the composition may include 1-(hydroxyhydrophosphoryl)butane-1,2,3,4-tetracarboxylic acid; 1-(hydroxyhydrophosphoryl)hexane-1,2,3,4,5,6-hexacarboxylic acid; and 1-(hydroxyhydrophosphoryl)octan-1,2,3,4,5,6,7,8-octacarboxylic acid.

In some embodiments, the method may include adding to the aqueous medium an additional corrosion inhibitor selected from: zinc, tin, aluminum, manganese, nickel, silicate, molybdate, strontium, titanium, chromate, cobalt, cerium, any salt thereof, any oxide thereof, and any combination thereof.

In some embodiments, the method may include adding an additional corrosion inhibitor to the aqueous medium, wherein the additional corrosion inhibitor comprises zinc or any oxide thereof.

In some embodiments, the polymer may include one or more monomers selected from: acrylic acid, 2-acrylamido-2-methylpropane sulfonic acid, itaconic acid, tertiary butyl acrylamide, acrylamide, methacrylamide, and any combination thereof.

In some embodiments, the method may include adding benzotriazole to the aqueous medium.

In some embodiments, the composition may include from about 5% to about 50% by weight of the compound of formula (I) or salt thereof.

In some embodiments, the composition may include from about 0.5% to about 15% by weight of the additional corrosion inhibitor.

In some embodiments, the method may include adding, or generating in situ, an oligomeric maleic acid or oligomeric maleic anhydride of formula (II) or oligomeric maleic anhydride of formula (III) to the aqueous medium,

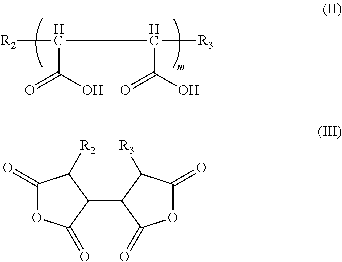

where m is 1, 2, 3, 4, 5, or 6; and R₂ and R₃ are independently selected from the group consisting of hydrogen, substituted or unsubstituted C₁-C₁₀ alkyl, substituted or unsubstituted C₄-C₆ aryl, substituted or unsubstituted C₁-C₁₀ alkoxy, hydroxyl, cumene, meistylene, toluene, and xylene.

In some embodiments, the method may include adding or generating in situ 1,2,3,4-butane tetracarboxylic acid or any salt thereof to the aqueous medium.

In some embodiments, the compound of formula (I) or salt thereof may be added to the aqueous medium in an amount ranging from about 1 ppm to about 100 ppm.

In some embodiments, the method may include adding benzotriazole to the aqueous medium in an amount ranging from about 0.1 ppm to about 50 ppm.

In some embodiments, the polymer is added to the aqueous medium in an amount ranging from about 0.5 ppm to about 50 ppm.

In other embodiments, a composition is disclosed. The composition may include a polymer and a compound of formula (I) or salt thereof,

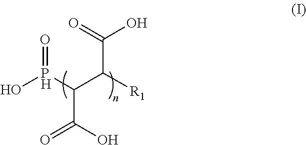

where R₁ is hydrogen, hydroxy, or a C₁-C₄ carboxyalkyl group; and n is 1, 2, 3, 4, or 5.

In some embodiments, the composition may include an additional corrosion inhibitor selected from: zinc, tin, aluminum, manganese, nickel, silicate, molybdate, strontium, titanium, chromate, cobalt, cerium, any salt thereof, any oxide thereof, and any combination thereof.

In some embodiments, the composition may include an additional corrosion inhibitor selected from: zinc, manganese, nickel, molybdate, chromate, cobalt, any salt thereof, any oxide thereof, and any combination thereof.

In some embodiments, the additional corrosion inhibitor is zinc or any oxide thereof.

In some embodiments, the composition may include benzotriazole.

In some embodiments, the composition may include an oligomeric maleic acid or oligomeric maleic anhydride of formula (II) or oligomeric maleic anhydride of formula (III)

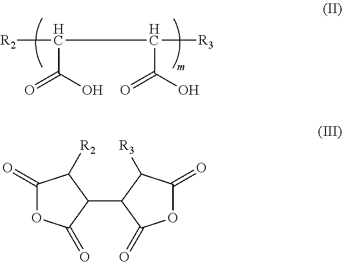

where m is 1, 2, 3, 4, 5, or 6; and R₂ and R₃ are independently selected from the group consisting of hydrogen, C₁-C₁₀ alkyl, C₄-C₆ aryl, C₁-C₁₀ alkoxy, hydroxyl, cumene, meistylene, toluene, and xylene.

In some embodiments, the composition may include 1,2,3,4-butane tetracarboxylic acid or any salt thereof.

In some embodiments, the composition is used to inhibit corrosion and/or scale.

The present disclosure also provides for the use of any of the inhibitor compositions disclosed herein for inhibiting corrosion or scale formation.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE DRAWINGS

A detailed description of the invention is hereafter described with specific reference being made to the drawings in which:

FIG. 1 shows a graphical analysis of the performance of a corrosion inhibitor composition in combination with low zinc;

FIG. 2 shows a graphical analysis of the performance of a corrosion inhibitor composition without zinc; and

FIG. 3 shows a graphical analysis of the performance of a scale inhibitor composition.

### DETAILED DESCRIPTION

Various embodiments are described below. The relationship and functioning of the various elements of the embodiments may better be understood by reference to the following detailed description. However, embodiments are not limited to those illustrated below. In certain instances details may have been omitted that are not necessary for an understanding of embodiments disclosed herein.

The present disclosure relates to corrosion inhibitor compositions and/or scale inhibitor compositions and methods for inhibiting corrosion and/or scale. Throughout the present disclosure, it is to be understood that reference to an “inhibitor composition” includes a corrosion inhibitor composition, a scale inhibitor composition and/or a composition that inhibits both scale and corrosion. The inhibitor compositions include hydrophosphorylated polycarboxylic acids. The inhibitor compositions can effectively reduce, inhibit, and/or prevent corrosion and/or scale in soft or hard water on surfaces, such as those comprising metals. In some aspects, the metals are ferrous metals, such as steel, iron, and alloys of iron with other metals, such as stainless steel.

The presently disclosed inhibitor compositions show strong efficacy as corrosion inhibitors for surfaces comprising carbon steel metallurgy, ferrous metals, and the like. The corrosion inhibitor compositions can achieve a high level of corrosion inhibition with low amounts of phosphorus. High levels of corrosion inhibition, such as less than about 1 mpy, may also be achieved when using a small amount of the presently disclosed corrosion inhibitor compositions.

The combination of hydrophosphorylated polycarboxylic acids with other additives produced synergistic results with unexpectedly high levels of corrosion and/or scale inhibition.

In some embodiments, a method of inhibiting corrosion and/or scale is disclosed. The method may include adding a composition to an aqueous medium comprising a metallic surface. The composition may include a polymer and a compound of formula (I) or salt thereof,

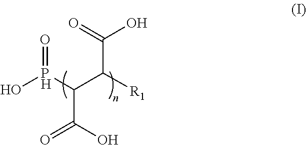

where R₁ is hydrogen, hydroxy, or a C₁-C₄ carboxyalkyl group; and n is 1, 2, 3, 4, or 5.

“Carboxyalkyl” refers to a group comprising an alkyl and a carboxy group.

“Alkyl” refers to a straight-chain or branched alkyl substituent. Examples of such substituents include methyl, ethyl, propyl, isopropyl, n-butyl, sec-butyl, isobutyl, tert-butyl, pentyl, isoamyl, hexyl, and the like.

The compounds of formula (I) or salts thereof may be prepared by reacting maleic acid with a hypophosphite, such as sodium hypophosphite, at a pH of about 1 to about 3 and a temperature of about 70° C. A persulfate, such as sodium persulfate, is added dropwise to the reaction mixture.

In some embodiments, R₁ is hydrogen. In some embodiments, R₁ is hydroxy. In some embodiments, R₁ is a C₁-C₄ carboxyalkyl group.

In some embodiments, n is 2, 3, or 4. In some embodiments, n is 2. In some embodiments, n is 3. In some embodiments, n is 4.

In some embodiments, the compound of formula (I) or salt thereof may be 2-(hydroxyhydrophosphoryl)succinic acid; 1-(hydroxyhydrophosphoryl)butane-1,2,3,4-tetracarboxylic acid; 1-(hydroxyhydrophosphoryl)hexane-1,2,3,4,5,6-hexacarboxylic acid; 1-(hydroxyhydrophosphoryl)octan-1,2,3,4,5,6,7,8-octacarboxylic acid; 1-hydroxy-4-(hydroxyhydrophosphoryl)butane-1,2,3,4-tetracarboxylic acid; sodium 3,4,5,6-tetracarboxy-2-(carboxymethyl)-6-(hydroxyhydrophosphoryl)hexanoate; or any combination thereof.

In some embodiments, the compound of formula (I) or salt thereof may be 1-(hydroxyhydrophosphoryl)butane-1,2,3,4-tetracarboxylic acid; 1-(hydroxyhydrophosphoryl)hexane-1,2,3,4,5,6-hexacarboxylic acid; 1-(hydroxyhydrophosphoryl)octan-1,2,3,4,5,6,7,8-octacarboxylic acid; or any combination thereof.

In some embodiments, the compound of formula (I) or salt thereof may be 1-(hydroxyhydrophosphoryl)butane-1,2,3,4-tetracarboxylic acid.

In some embodiments, the compound of formula (I) or salt thereof may be 1-(hydroxyhydrophosphoryl)hexane-1,2,3,4,5,6-hexacarboxylic acid.

In some embodiments, the compound of formula (I) or salt thereof may be 1-(hydroxyhydrophosphoryl)octan-1,2,3,4,5,6,7,8-octacarboxylic acid.

In some embodiments, the composition may include 1-(hydroxyhydrophosphoryl)butane-1,2,3,4-tetracarboxylic acid; 1-(hydroxyhydrophosphoryl)hexane-1,2,3,4,5,6-hexacarboxylic acid; and 1-(hydroxyhydrophosphoryl)octan-1,2,3,4,5,6,7,8-octacarboxylic acid.

In certain embodiments, the salt of the compound of formula (I) may be any salt, such as a chloride salt, bromide salt, iodide salt, sulfate salt, fluoride salt, perchlorate salt, acetate salt, trifluoroacetate salt, phosphate salt, nitrate salt, carbonate salt, bicarbonate salt, formate salt, chlorate salt, bromated salt, chlorite salt, thiosulfate salt, oxalate salt, cyanide salt, cyanate salt, tetrafluoroborate salt, and the like. In some embodiments, the salt of the compound of formula (I) may be a hydrochloride or sulfate salt.

In some embodiments, the polymer may include one or more monomers, such as acrylic acid, 2-acrylamido-2-methylpropane sulfonic acid (AMPS), itaconic acid, tertiary butyl acrylamide, acrylamide, methacrylamide, or any combination thereof. The polymer may be a homopolymer, copolymer, terpolymer, tetrapolymer, etc., comprising varying proportions of monomers not limited to those listed above. In certain embodiments, the polymer may include about 80 to about 99 mole percent acrylic acid and from about 1 to about 20 mole percent AMPS. In some embodiments, the copolymer may comprise about 95% acrylic acid and about 4% AMPS or about 90% acrylic acid and about 10% AMPS. In other embodiments, the polymer may be a tetrapolymer comprising acrylic acid, itaconic acid, AMPS, and tertiary butyl acrylamide in any mole percent. Other polymers that may be used in the inhibitor compositions include, but are not limited to, copolymers of acrylic acid and AMPS comprising about 40 to about 70% acrylic acid and about 30 to about 60% AMPS. In other embodiments, the polymer may be a copolymer comprising about 60% acrylic acid and about 40% AMPS or about 50% acrylic acid and about 50% AMPS.

In some embodiments, the polymer may have a weight average molecular weight of about 5,000 Da to about 50,000 Da. In some embodiments, the polymer may have a weight average molecular weight of about 20,000 Da.

In certain embodiments, the composition comprises an effective amount of polymer, which may be appropriately selected by one of skill in the art. The amount of polymer added to the aqueous system may range from about 0.1 ppm to about 100 ppm. In other embodiments, the amount of polymer may range from about 1 ppm to about 50 ppm, about 0.5 ppm to about 20 ppm, about 1 ppm to about 10 ppm, or about 1 ppm to about 20 ppm. In other embodiments, the amount of polymer may range from about 5 ppm to about 30 ppm, about 10 ppm to about 20 ppm, or about 5 ppm to about 20 ppm. In some embodiments, the amount of polymer added to the aqueous system may be about 5 ppm, about 6 ppm, about 7 ppm, about 8 ppm, about 9 ppm, about 10 ppm, about 11 ppm, about 12 ppm, about 13 ppm, about 14 ppm, or about 15 ppm.

In some embodiments, the method may also include adding to the aqueous medium an additional corrosion inhibitor, such as zinc, tin, aluminum, manganese, nickel, silicate, molybdate, strontium, titanium, chromate, cobalt, cerium, any salt thereof, any oxide thereof, or any combination thereof. In some embodiments, the additional corrosion inhibitor may include zinc or any oxide thereof. The additional corrosion inhibitors may be in the form of any salt or any oxide. Illustrative, non-limiting examples of inorganic salts may be chloride, nitrate, nitrite, or sulfate. The salt form may be organic including, but not limited to, acetate or citrate salts.

In some embodiments, the method may include adding benzotriazole to the aqueous medium.

In some embodiments, the composition that is added to the aqueous medium may include from about 5% to about 50% by weight of the compound of formula (I) or salt thereof.

In some embodiments, the composition may include from about 0.5% to about 15% by weight of the additional corrosion inhibitor.

In other embodiments, the method may include adding an oligomeric maleic acid or oligomeric maleic anhydride of formula (II) or oligomeric maleic anhydride of formula (III) to the aqueous medium,

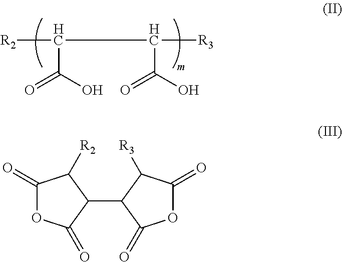

where m is 1, 2, 3, 4, 5, or 6; and R₂ and R₃ are independently selected from hydrogen, substituted or unsubstituted C₁-C₁₀ alkyl, substituted or unsubstituted C₄-C₆ aryl, substituted or unsubstituted alkoxy, hydroxyl, cumene, meistylene, toluene, and xylene.

The amount of the compounds of formula (II) or (III) in the aqueous system after the composition has been added may range from about 0.1 ppm to about 100 ppm. In other embodiments, the amount may range from about 1 ppm to about 50 ppm, about 1 ppm to about 10 ppm, or about 1 ppm to about 20 ppm. In other embodiments, the amount may range from about 10 ppm to about 50 ppm, about 10 ppm to about 40 ppm, or about 20 ppm to about 50 ppm.

In some embodiments, the method may include adding 1,2,3,4-butane tetracarboxylic acid or any salt thereof to the aqueous medium.

In some embodiments, the compound of formula (I) or salt thereof is added to the aqueous medium in an amount ranging from about 1 ppm to about 100 ppm. In other embodiments, the compound of formula (I) or salt thereof is added to the aqueous medium in an amount ranging from about 5 ppm to about 50 ppm, about 5 ppm to about 40 ppm, about 5 ppm to about 30 ppm, about 10 ppm to about 30 ppm, or about 15 ppm to about 25 ppm. In some embodiments, the compound of formula (I) or salt thereof is added to the aqueous medium in an amount of about 20 ppm.

In some embodiments, the method may include adding benzotriazole to the aqueous medium in an amount ranging from about 0.1 ppm to about 10 ppm. In other embodiments, the amount of benzotriazole added to the aqueous medium may be about 0.1 to about 5 ppm. In other embodiments, the amount of benzotriazole added to the aqueous medium may be about 1 ppm, about 2 ppm, about 3 ppm, about 4 ppm, or about 5 ppm. In certain embodiments, the amount of benzotriazole added to the aqueous medium may be about 2 ppm.

Each component may be added separately or as a mixture and the addition may be manual addition or automatic addition using chemical injection pumps and the automated system described herein. The compositions (or components thereof) may be dosed periodically or continuously into the aqueous system. In some embodiments, the polymer and the compound or salt thereof of formula (I) may be added to the aqueous medium together or separately. In some embodiments, the polymer and the compound or salt thereof of formula (I) may be mixed together in a composition before addition into the aqueous system.

In certain aspects of the present disclosure, an effective amount of zinc may be added directly to the surface to be treated and/or it may be added to the aqueous system containing one or more surfaces susceptible of corrosion along with the corrosion inhibitor composition. Zinc may act as a cathodic corrosion inhibitor and corrosion inhibition may improve with higher amounts of zinc.

In some embodiments, the aqueous system includes a biocide, such as bleach. The aqueous system may be a part of an industrial water system. “Industrial water system” means any system that circulates water as its primary ingredient. Non-limiting examples of “industrial water systems” include cooling systems, boiler systems, heating systems, membrane systems, papermaking systems, or any other systems that circulate water. Bleach may be added to any of these industrial water systems to control microbial growth. An advantage of the compounds of formula (I) is that they are stable in the presence of biocides.

In certain embodiments, a composition is disclosed that includes a polymer and a compound of formula (I) or salt thereof,

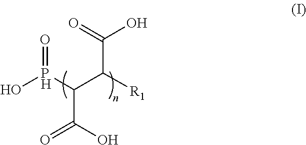

where R₁ is hydrogen, hydroxy, or a C₁-C₄ carboxyalkyl group; and n is 1, 2, 3, 4, or 5.

In some embodiments, the composition may include an additional corrosion inhibitor, such as zinc, tin, aluminum, manganese, nickel, silicate, molybdate, strontium, titanium, chromate, cobalt, cerium, any salt thereof, any oxide thereof, or any combination thereof.

In other embodiments, the composition may include an additional corrosion inhibitor selected from zinc, manganese, nickel, molybdate, chromate, cobalt, any salt thereof, any oxide thereof, or any combination thereof. In some embodiments, the additional corrosion inhibitor may be zinc or any oxide thereof. The additional corrosion inhibitors may be in the form of any salt or any oxide. Illustrative, non-limiting examples of inorganic salts may be chloride, nitrate, nitrite, or sulfate. The salt form may be organic including, but not limited to, acetate or citrate salts.

In certain embodiments, the composition may include benzotriazole.

In other embodiments, the composition may consist of a compound of formula (I) or salt thereof, a polymer, zinc, and benzotriazole. In other embodiments, the composition may consist of a compound of formula (I) or salt thereof, a polymer, and zinc. In other embodiments, the composition may consist of a compound of formula (I) or salt thereof and zinc. In some embodiments, the composition may exclude formic acid or phosphinicobis(succinic acid) compounds.

In some embodiments, the polymer in the composition may include one or more monomers, such as acrylic acid, AMPS, itaconic acid, tertiary butyl acrylamide, acrylamide, methacrylamide, or any combination thereof. The polymer may be a homopolymer, copolymer, terpolymer or tetrapolymer comprising varying proportions of monomers not limited to those listed above. In certain embodiments, the polymer may include about 80 to about 99 mole percent acrylic acid and from about 1 to about 20 mole percent AMPS. In some embodiments, the copolymer may comprise about 95% acrylic acid and about 4% AMPS or about 90% acrylic acid and about 10% AMPS. In other embodiments, the polymer may be a tetrapolymer comprising acrylic acid, itaconic acid, AMPS, and tertiary butyl acrylamide in any mole percent. Other polymers that may be used in the inhibitor compositions include, but are not limited to, copolymers of acrylic acid and AMPS comprising about 40 to about 70% acrylic acid and about 30 to about 60% AMPS. In other embodiments, the polymer may be a copolymer comprising about 60% acrylic acid and about 40% AMPS or about 50% acrylic acid and about 50% AMPS.

In some embodiments, the composition may include an oligomeric maleic acid or oligomeric maleic anhydride of formula (II) or oligomeric maleic anhydride of formula (III)

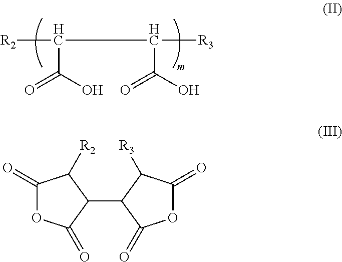

where the variable “n” may be 1, 2, 3, 4, 5, or 6. Additionally, the compounds of formulae (II) or (III) may be substituted at the R₂ and R₃ position with a suitable substituent. Suitable substituents may include hydrogen, substituted or unsubstituted C₁-C₁₀ alkyl, substituted or unsubstituted C₄ to C₆ aryl, substituted or unsubstituted C₁ to C₁₀ alkoxy, or hydroxyl. Substituents may also include cumene, meistylene, toluene, or xylene. The compounds of formulae (II) and (III) may be synthesized in organic solvents such as, cumene, meistylene, toluene, xylene, and the like, or in water. Appropriate catalysts and reaction conditions may be used as needed.

In some embodiments, the composition may include 1,2,3,4-butane tetracarboxylic acid or any salt thereof.

In some embodiments, the composition may include from about 5% to about 50% by weight of the compound of formula (I) or salt thereof.

In some embodiments, the composition may include from about 0.5% to about 15% by weight of an additional corrosion inhibitor.

In some embodiments, the weight ratio of the compound of formula (I) or salt thereof to the additional corrosion inhibitor is about 10:1. In some embodiments, the weight ratio is about 1:1, about 2:1, about 3:1, about 4:1, or about 5:1.

The compounds of formula (II) or (III) may have any one of the following structures:

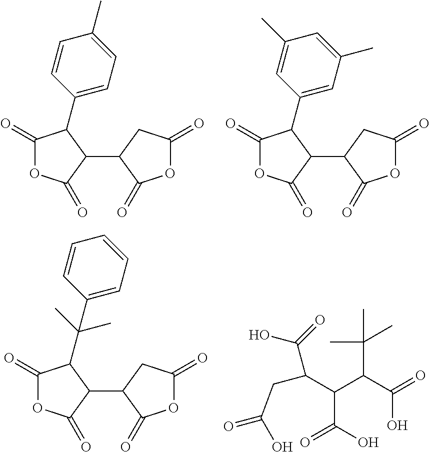

In some embodiments, any of the compositions in the present disclosure may include a triazole. Illustrative triazoles include, but are not limited to, toly triazole, benzotriazole, and butyl benzo triazole.

The present disclosure also includes methods of using the compositions disclosed herein to prevent, reduce, and/or inhibit corrosion and/or scale. It is to be understood that when referring to methods of inhibiting corrosion and/or scale, methods of preventing and/or reducing corrosion and/or scale are also included. In some embodiments, a method of inhibiting scale and/or corrosion of a metallic surface in an aqueous system includes adding a corrosion and/or scale inhibitor composition to the aqueous system.

The presently disclosed inhibitor compositions may be used in any aqueous system comprising surfaces susceptible of corrosion and/or scale. For example, the inhibitor compositions may be used in once-through, open loop, or closed loop recirculating cooling water systems. Other aqueous systems include, but are not limited to, systems used in petroleum production and oil recovery (e.g., well casing transport pipelines, etc.) and refining, geothermal wells, and other oil field applications; boilers and boiler water systems; systems used in power generation, mineral process waters including mineral washing, flotation and benefaction; paper mill digesters, washers, bleach plants, white water systems and mill water systems; black liquor evaporators in the pulp industry; gas scrubbers and air washers; continuous casting processes in the metallurgical industry; air conditioning and refrigeration systems; building fire protection heating water, such as pasteurization water; water reclamation and purification systems; membrane filtration water systems; food processing streams and waste treatment systems as well as in clarifiers, liquid-solid applications, municipal sewage treatment systems; and industrial or municipal water distribution systems.

In particular aspects of the present disclosure, the inhibitor compositions may be used in connection with warewashing compositions. Warewashing compositions may be used for protecting articles, such as glassware or silverware, from corrosion in a dishwashing or warewashing machine. However, it is to be understood that the warewashing compositions comprising the presently disclosed inhibitor compositions can be available for cleaning environments other than inside a dishwashing or warewashing machine.

In certain embodiments, the disclosed inhibitor compositions may have one or more of the following characteristics:
Halogen stability up to about 0.5 ppm free residual chlorine (FRC);
Ability to handle water temperatures up to about 60° C.;
Compatibility with azoles, dispersants, and cooling water polymers;
Calcium tolerance up to about 500 ppm as CaCO₃;
Chloride tolerance up to about 600 ppm as Cl;
Stability over a pH from about 6 to about 9;
Low toxicity (e.g. LC₅₀>100 mg/L); and
Stable for a Holding Time Index (HTI) of from a few seconds up to about 240 hours.

Those skilled in the art will appreciate that compounds of formula (I) can be added to an aqueous system alone or in combination with other corrosion inhibitors or treatment chemicals, such as triazoles, benzotriazoles (e.g., benzotriazole or tolyltriazole), benzimidazoles, orthophosphate, polyphosphates, phosphonates, molybdates, silicates, oximes, and nitrites. The compounds of formula (I) can be added to an aqueous system in combination with a variety of additional additives, such as treatment polymers, anti-microbial agents, anti-scaling agents, colorants, fillers, buffers, surfactants, viscosity modifiers, chelating agents, dispersants, deodorants, masking agents, oxygen scavengers, and indicator dyes.

Any of the presently disclosed aqueous systems may be automatically monitored and controlled. For example, the pH of the systems may be monitored and controlled or the amount of inhibitor composition in the aqueous system may be monitored and controlled.

The present disclosure also describes an on-line unit and system for measuring, controlling, and/or optimizing one or more system parameters or properties of water. Optimization can include, for example, measuring one or more properties associated with the water to be sure that the one or more properties are within an acceptable, predetermined range and, if the one or more properties are not within the acceptable, predetermined range for each respective property being measured, causing a change in the water to bring the property back within the acceptable, predetermined range.

In certain embodiments, the system includes a monitoring and controlling unit that comprises a controller and a plurality of sensors. Each of the plurality of sensors can be in communication with the controller. For example, if the unit comprises five sensors, each of the five sensors can be in communication with the controller. In certain aspects, the controller can be attached to a skid, or other type of support member, to allow for mobility.

As used herein, the term “controller” refers to a manual operator or an electronic device having components, such as a processor, memory device, digital storage medium, a communication interface including communication circuitry operable to support communications across any number of communication protocols and/or networks, a user interface (e.g., a graphical user interface that may include cathode ray tube, liquid crystal display, plasma display, touch screen, or other monitor), and/or other components.

The controller is preferably operable for integration with one or more application-specific integrated circuits, programs, computer-executable instructions or algorithms, one or more hard-wired devices, wireless devices, and/or one or more mechanical devices. Moreover, the controller is operable to integrate the feedback, feed-forward, and/or predictive loop(s) of the invention. Some or all of the controller system functions may be at a central location, such as a network server, for communication over a local area network, wide area network, wireless network, internet connection, microwave link, infrared link, wired network (e.g., Ethernet) and the like. In addition, other components, such as a signal conditioner or system monitor, may be included to facilitate signal transmission and signal-processing algorithms.

In certain aspects, the controller includes hierarchy logic to prioritize any measured or predicted properties associated with system parameters. For example, the controller may be programmed to prioritize system pH over conductivity, or vice versa. It should be appreciated that the object of such hierarchy logic is to allow improved control over the system parameters and to avoid circular control loops.

In some embodiments, the monitoring and controlling unit and method associated therewith includes an automated controller. In some embodiments, the controller is manual or semi-manual. For example, when the system includes one or more datasets received from various sensors in the system, the controller may either automatically determine which data points/datasets to further process or an operator may partially or fully make such a determination. A dataset for an industrial body of water, for instance, may include variables or system parameters such as oxidation/reduction potential (ORP), dissolved oxygen (DO), conductivity, pH, turbidity, concentrations of certain chemicals, such as biocides, scale inhibitors, friction reducers, acids, bases, and/or oxygen scavengers, levels of ions (e.g., determined empirically, automatically, fluorescently, electrochemically, colorimetrically, measured directly, calculated), temperature, pressure, flow rate, total dissolved or suspended solids, etc. Such system parameters are typically measured with any type of suitable data capturing equipment, such as sensors designed specifically for these parameters, e.g., pH sensors, ion analyzers, temperature sensors, thermocouples, pressure sensors, corrosion probes, and/or any other suitable device or sensor. Data capturing equipment is in communication with the controller and, according to some embodiments, may have advanced functions (including any part of the control algorithms described herein) imparted by the controller.

The monitoring and controlling unit may comprise a plurality of sensors, which are capable of analyzing the water and transmitting data regarding the water to the controller. The plurality of sensors can comprise, for example, sensors for measuring conductivity, pH, ORP, biocide concentration, turbidity, temperature, flow, and DO in the water. The monitoring and controlling unit may comprise any of these sensors, all of these sensors, a combination of two or more of these sensors, one or more additional sensors not specifically mentioned here, and the sensors may be in communication with the controller. Other types of sensors contemplated by the present disclosure include, but are not limited to, oil in water sensors, total dissolved solids sensors, and total suspended solids sensors.

The presently disclosed monitoring and controlling system comprises, in certain embodiments, one or more chemical injection pumps. Each chemical injection pump may be in fluid communication with a storage device. Each storage device may comprise one or more chemicals and the chemical injection pumps may transport those chemicals into the body of water. In some embodiments, the chemical injection pump comprises the storage device. The chemical injection pumps may be in communication with the controller in any number of ways, such as through any combination of wired connection, a wireless connection, electronically, cellularly, through infrared, satellite, or according to any other types of communication networks, topologies, protocols, standards and more. Accordingly, the controller can send signals to the pumps to control their chemical feed rates.

In certain embodiments, the monitoring and controlling system is implemented to have the plurality of sensors provide continuous or intermittent feedback, feed-forward, and/or predictive information to the controller, which can relay this information to a relay device, such as the Nalco Global Gateway, which can transmit the information via cellular communications to a remote device, such as a cellular telephone, computer, and/or any other device that can receive cellular communications. This remote device can interpret the information and automatically send a signal (e.g. electronic instructions) back, through the relay device, to the controller to cause the controller to make certain adjustments to the output of the pumps. The information can also be processed internally by the controller and the controller can automatically send signals to the pumps to adjust the amount of chemical injection, for example. Based upon the information received by the controller from the plurality of sensors or from the remote device, the controller may transmit signals to the various pumps to make automatic, real-time adjustments, to the amount of chemical that the pumps are injecting into the water.

Alternatively, an operator of the remote device that receives cellular communications from the controller can manually manipulate the pumps through the remote device. The operator may communicate instructions, through the remote device, cellularly or otherwise, to the controller and the controller can make adjustments to the rate of chemical addition of the chemical injection pumps. For example, the operator can receive a signal or alarm from the remote device through a cellular communication from the controller and send instructions or a signal back to the controller using the remote device to turn on one or more of the chemical injection pumps, turn off one or more of the chemical injection pumps, increase or decrease the amount of chemical being added to the water by one or more of the injection pumps, or any combination of the foregoing. The controller and/or the remote device is also capable of making any of the foregoing adjustments or modifications automatically without the operator actually sending or inputting any instructions. Preset parameters or programs are entered into the controller or remote device so that the controller or remote device can determine if a measured property is outside of an acceptable range. Based on the information received by the plurality of sensors, the controller or remote device can make appropriate adjustments to the pumps or send out an appropriate alert.

In certain embodiments, the remote device or controller can include appropriate software to receive data from the plurality of sensors and determine if the data indicates that one or more measured properties of the water are within, or outside, an acceptable range. The software can also allow the controller or remote device to determine appropriate actions that should be taken to remedy the property that is outside of the acceptable range. For example, if the measured pH is above the acceptable range, the software allows the controller or remote device to make this determination and take remedial action, such as alerting a pump to increase the flow of an acid into the body of water.

The monitoring and controlling system and/or controller disclosed herein can incorporate programming logic to convert analyzer signals from the plurality of sensors to pump adjustment logic and, in certain embodiments, control one or more of a plurality of chemical injection pumps with a unique basis. Non-limiting, illustrative examples of the types of chemical injection pumps that can be manipulated include chemical injection pumps responsible for injecting biocides, scale inhibitors, friction reducers, acids, bases, sulfites, oxygen scavengers, and any other type of chemical that could prove to be useful in the particular aqueous industrial system. Particular examples of biocides, scale inhibitors, friction reducers, acids, bases, sulfites, and oxygen scavengers are all well-known in the art and all examples of such chemicals are within the scope of the present disclosure.

The sensors disclosed herein are operable to sense and/or predict a property associated with the water or system parameter and convert the property into an input signal, e.g., an electric signal, capable of being transmitted to the controller. A transmitter associated with each sensor transmits the input signal to the controller. The controller is operable to receive the transmitted input signal, convert the received input signal into an input numerical value, analyze the input numerical value to determine if the input numerical value is within an optimum range, generate an output numerical value, convert the output numerical value into an output signal, e.g., an electrical signal, and transmit the output signal to a receiver, such as a pump incorporating such receiver capabilities or a remote device, such as a computer or cellular telephone, incorporating receiver capabilities. The receiver receives the output signal and either alerts an operator to make adjustments to flow rates of the pumps, or the receiver can be operable to cause a change in a flow rate of the pumps automatically, if the output numerical value is not within the acceptable range for that property.

The method is optionally repeated for a plurality of different system parameters, where each different system parameter has a unique associated property, or, alternatively, all system parameters can be analyzed concurrently by the plurality of sensors.

Data transmission of measured parameters or signals to chemical pumps, alarms, remote monitoring devices, such as computers or cellular telephones, or other system components is accomplished using any suitable device, and across any number of wired and/or wireless networks, including as examples, WiFi, WiMAX, Ethernet, cable, digital subscriber line, Bluetooth, cellular technologies (e.g., 2G, 3G, Universal Mobile Telecommunications System (UMTS), GSM, Long Term Evolution (LTE), or more) etc. The Nalco Global Gateway is an example of a suitable device. Any suitable interface standard(s), such as an Ethernet interface, wireless interface (e.g., IEEE 802.11a/b/g/x, 802.16, Bluetooth, optical, infrared, radiofrequency, etc.), universal serial bus, telephone network, the like, and combinations of such interfaces/connections may be used.

As used herein, the term “network” encompasses all of these data transmission methods. Any of the described devices (e.g., archiving systems, data analysis stations, data capturing devices, process devices, remote monitoring devices, chemical injection pumps, etc.) may be connected to one another using the above-described or other suitable interface or connection.

In some embodiments, system parameter information is received from the system and archived. In certain embodiments, system parameter information is processed according to a timetable or schedule. In some embodiments, system parameter information is immediately processed in real-time or substantially real-time. Such real-time reception may include, for example, “streaming data” over a computer network.

The chemicals to be added to the system, such as the acids, bases, biocides, scale inhibitors, friction reducers, etc., may be introduced to the system using any suitable type of chemical injection pump. Most commonly, positive displacement injection pumps are used and are powered either electrically or pneumatically. Continuous flow injection pumps can also be used to ensure specialty chemicals are adequately and accurately injected into the rapidly moving process stream. Though any suitable pump or delivery system may be used, exemplary pumps and pumping methods include those disclosed in U.S. Pat. No. 5,066,199, titled “Method for Injecting Treatment Chemicals Using a Constant Flow Positive Displacement Pumping Apparatus” and U.S. Pat. No. 5,195,879, titled “Improved Method for Injecting Treatment Chemicals Using a Constant Flow Positive Displacement Pumping Apparatus,” each incorporated herein by reference in its entirety.

In some embodiments, changes in the chemical injection pumps are limited in frequency. In some aspects, adjustment limits are set at a maximum of 1 per 15 min and sequential adjustments in the same direction may not exceed 8, for example. In some embodiments, after 8 total adjustments or a change of 50% or 100%, the pump could be suspended for an amount of time (e.g., 2 or 4 hours) and alarm could be triggered. If such a situation is encountered, it is advantageous to trigger an alarm to alert an operator. Other limits, such as maximum pump output, may also be implemented. It should be appreciated that it is within the scope of the invention to cause any number of adjustments in any direction without limitation. Such limits are applied as determined by the operator or as preset into the controller.

In accordance with certain embodiments of the present disclosure, a method of monitoring and controlling corrosion of a metal surface and/or scale of a surface in an aqueous industrial system is provided.

The method includes the use of a monitoring and controlling unit comprising a controller and a plurality of sensors in communication with the controller. Each of the plurality of sensors is operable to measure a property of the water. For example, in some embodiments, the unit comprises five sensors, wherein each sensor is operable to measure a different property, such as pH, temperature, flow, conductivity, and corrosion rate.

One or more pumps, which are in communication with the controller, are utilized to inject various chemicals into the water, such as corrosion inhibitors, biocides, and oxygen scavengers. Each chemical may have its own chemical injection pump.

An acceptable range for each of the one or more properties of the water to be measured is entered into the controller.

A conduit may be provided between the aqueous industrial system and the monitoring and controlling unit. A sample of water passes through the conduit and into an inlet of the monitoring and controlling unit. Next, one or more properties of the water are measured using a plurality of sensors and the controller determines if the measured one or more properties are within the acceptable range entered into the controller in the previous step. This determining step can be automatically performed by the controller and in this step, the measured value for each measured property is compared to the acceptable range entered for that specific property.

If the measured one or more properties are outside of the acceptable range associated with that property, the controller and/or operator of the controller may cause a change, for example, in an influx of a chemical, such as a corrosion inhibitor, into the aqueous industrial system from the one or more chemical injection pumps, the chemical(s) being capable of adjusting the measured property and bringing it back within the acceptable range. The controller is operable to determine when the measured property is back within the acceptable range and subsequently turn off the chemical injection pump(s).

### EXAMPLES

### Example 1

To a 1000 mL four neck reaction flask equipped with a mechanical stirrer, a condenser, a drop-funnel, a nitrogen gas inlet pipe, and a thermometer were added about 330 grams of maleic acid, about 120 grams of NaH₂PO₂, and about 436 grams of water. Maleic acid and NaH₂PO₂ were dissolved in the water and the reaction system temperature was increased to about 70° C. Na₂S₂O₈ (about 34 grams) as a 30% by weight aqueous solution (114 grams) was gradually added to the reaction mixture through the drop-funnel. About 5 minutes after the start of Na₂S₂O₈ addition, cooling water was turned on to keep the temperature at about 70° C. The Na₂S₂O₈ solution was added within the first hour, and the reaction mixture was kept at about 70° C. for about another 2 hours. The temperature was then raised and kept at about 75-80° C. for an additional 3 hours.

Portions of the aqueous reaction product were taken from the reactor at various reaction times. The maleic acid polymerization products with different reaction times (0, 0.5, 1.0, 2.0, 4.0, and 6.0 hours). Phosphate analysis was conducted on the final reaction product to determine the amount of phosphate in the forms of P and PO4. A 20 ppm dosage of the reaction product contains about 2.5 ppm total phosphate with about 0.8 ppm as P.

### Example 2

Electrochemical Gamry technique was used for measuring corrosion inhibition performance of the compositions. The test was performed using three different types of water matrices: soft, medium soft, and high hardness chloride water. The water chemistry was prepared by adding the required amount of mineral salts (as source for different metal cations and anions) in deionized water.

The composition of test water contained Ca (as calcium carbonate)=100 mg/L; Mg (as calcium carbonate)=50 mg/L; M-alkalinity=100 mg/L; Chloride as Cl=200 mg/L; and Sulfate as SO₄=100 mg/L. The pH of the water was about 8.2.

About 800 ml of the test water was used in a 1 Liter round bottom glass flask, which was heated using a temperature controller to about 120° F., and the solution was simultaneously purged with air. The study was done in an aerated system, and the pH was maintained at about 8.0-8.2 with CO₂, throughout the study. The corrosion inhibitor was dosed at about 10-30 ppm as active chemical.

The Gamry electrochemical instrument operates through a rotary electrode principle and contains a Rotating Cylinder Electrode, for which the rotator speed was set at 500 rpm. The experiment continued for about 48 hours. During the first 24 hours corrosion inhibition was measured in the absence of biocide. At the 24 hour mark, biocide was added, and corrosion inhibition was measured for the remaining 24 hours.

Gamry software collected the data through polarization resistance (Rp) measurements at a potential scan rate of 0.1 mV/second within 20 mV of the corrosion potential (Ecorr) from the cathodic region to the anodic region. A corrosion rate (mpy) versus time curve was plotted using the Gamry software and the steady state corrosion rate was determined with this plot.

A composition containing 1-(hydroxyhydrophosphoryl)butane-1,2,3,4-tetracarboxylic acid; 1-(hydroxyhydrophosphoryl)hexane-1,2,3,4,5,6-hexacarboxylic acid; and 1-(hydroxyhydrophosphoryl)octan-1,2,3,4,5,6,7,8-octacarboxylic acid was prepared and is referred to as “POMA” below.

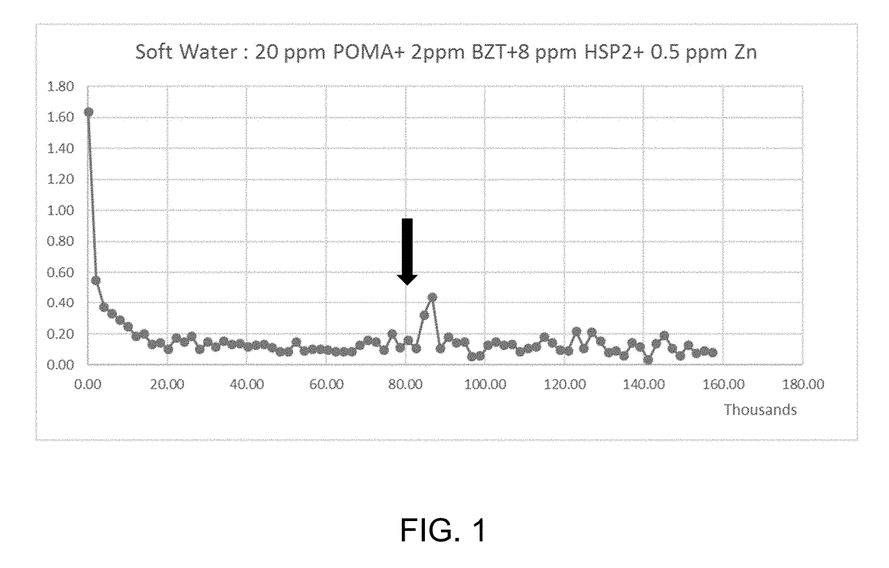

FIG. 1 shows the corrosion rate of metal in the presence of about 20 ppm POMA, about 2 ppm of benzotriazole, about 8 ppm of a copolymer of acrylic acid (60 mol %) and AMPS (40 mol %) having a weight average molecular weight of about 20,000 Da, and about 0.5 ppm zinc. The arrow indicates the moment when biocide was added to the water. Surprisingly, the corrosion level dropped below about 0.2 mpy even in the presence of biocide.

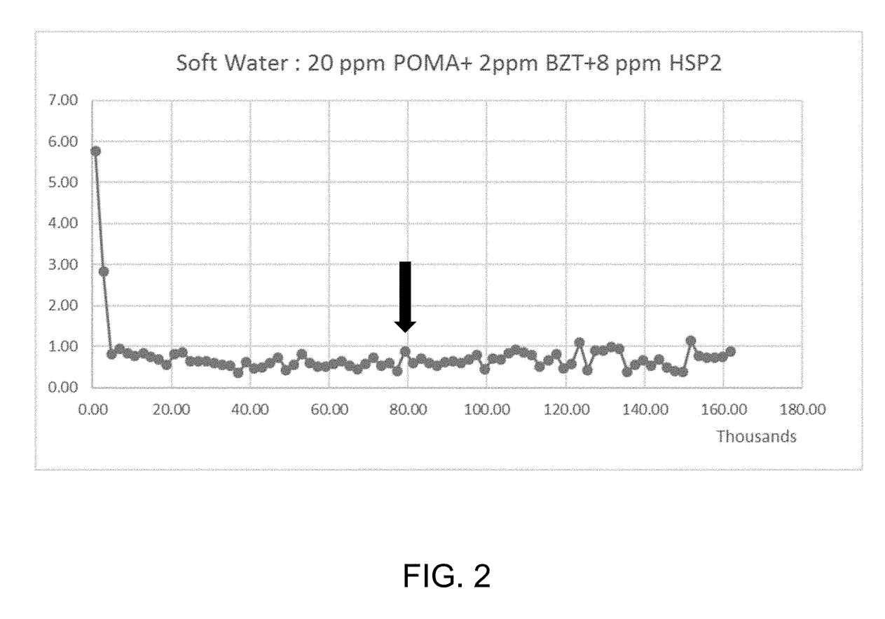

FIG. 2 shows the corrosion rate of metal in the presence of about 20 ppm POMA about 2 ppm benzotriazole, and about 8 ppm of a copolymer of acrylic acid (60 mol %) and AMPS (40 mol %) having a weight average molecular weight of about 20,000 Da. The arrow indicates the moment when biocide was added to the water. Corrosion rates were below about 1 mpy even in the presence of biocide.

### Example 3

Halogen stability of the compounds of formula (I) was evaluated by using mass spectrometry and NMR. All the compounds were found to be very stable at bleach concentrations of 2.03 ppm and 20.3 ppm. Under a bleach concentration of 101. 5 ppm, low-molecular weight compounds, such as where n is 1 or 2, are relatively more stable than high-molecular-weight compounds where n is 3 or 4. Overall, the stability of the compounds in the presence of bleach is very good.

### Example 4

POMA was also tested for scale inhibition, such as CaCO₃ scale inhibition, in cooling water conditions. Scale inhibition performance was evaluated using the dynamic bottle test at a pH of about 9 and a temperature of about 50° C. The length of the test was 24 hours and the conditions were Ca (500), Mg (280), Alk (600) as CaCO₃.

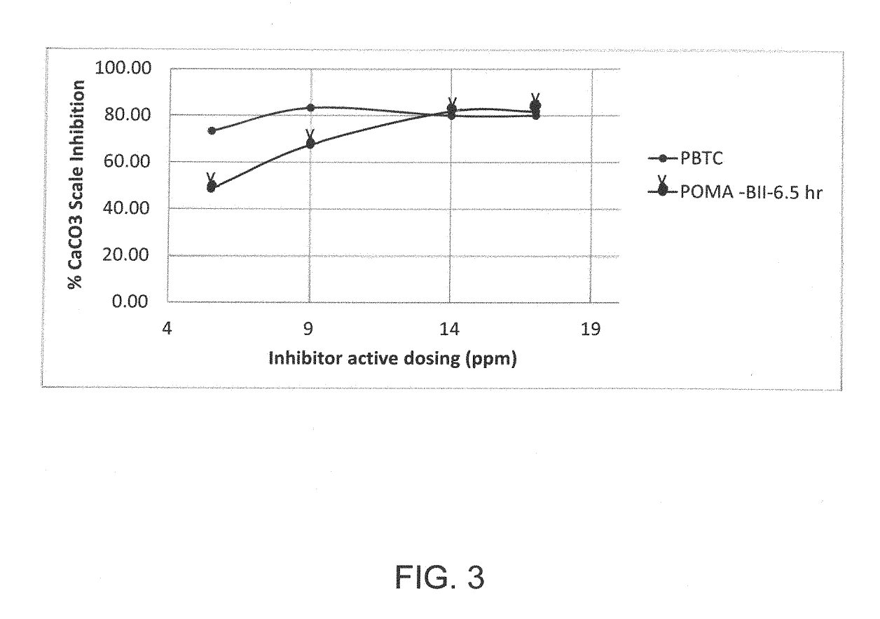

As can be seen in FIG. 3, at certain dosages the scale inhibition rate of POMA was better than PBTC (Phosphono butane tricarboxylic acid). Also, POMA was found to be highly stable in bleach conditions and no significant conversion to ortho phosphate was observed. The inhibitor composition was also found to have a tolerance to hardness.

Any composition disclosed herein may comprise, consist of, or consist essentially of any of the compounds/components disclosed herein. In accordance with the present disclosure, the phrases “consist essentially of,” “consists essentially of,” “consisting essentially of,” and the like limit the scope of a claim to the specified materials or steps and those materials or steps that do not materially affect the basic and novel characteristic(s) of the claimed invention.

As used herein, the term “about” refers to the cited value being within the errors arising from the standard deviation found in their respective testing measurements, and if those errors cannot be determined, then “about” refers to within 10% of the cited value.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a polymer” is intended to include “at least one polymer” or “one or more polymers.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of inhibiting corrosion and/or scale formation, comprising:
adding a composition to an aqueous medium, wherein the composition comprises a polymer and a compound of formula (I) or salt thereof, 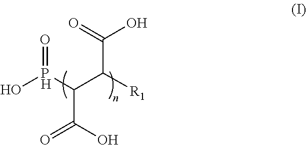
where R₁ is hydrogen, hydroxy, or a C₁-C₄ carboxyalkyl group; and
n is 1, 2, 3, 4, or 5.

2. The method of claim 1, wherein R₁ is hydrogen.

3. The method of claim 1, wherein n is 2, 3, or 4.

4. The method of claim 1, wherein the compound of formula (I) or salt thereof is selected from: 2-(hydroxyhydrophosphoryl)succinic acid; 1-(hydroxyhydrophosphoryl)butane-1,2,3,4-tetracarboxylic acid; 1-(hydroxyhydrophosphoryl)hexane-1,2,3,4,5,6-hexacarboxylic acid; 1-(hydroxyhydrophosphoryl)octan-1,2,3,4,5,6,7,8-octacarboxylic acid; 1-hydroxy-4-(hydroxyhydrophosphoryl)butane-1,2,3,4-tetracarboxylic acid; sodium 3,4,5,6-tetracarboxy-2-(carboxymethyl)-6-(hydroxyhydrophosphoryphexanoate; and any combination thereof.

5. The method claim 1, wherein the composition comprises 1-(hydroxyhydrophosphoryl)butane-1,2,3,4-tetracarboxylic acid; 1-(hydroxyhydrophosphoryl)hexane-1,2,3,4,5,6-hexacarboxylic acid; and 1-(hydroxyhydrophosphoryl)octan-1,2,3,4,5,6,7,8-octacarboxylic acid.

6. The method of claim 1, further comprising adding to the aqueous medium an additional corrosion inhibitor selected from: zinc, tin, aluminum, manganese, nickel, silicate, molybdate, strontium, titanium, chromate, cobalt, cerium, any salt thereof, any oxide thereof, and any combination thereof.

7. The method of claim 1, wherein the polymer comprises one or more monomers selected from: acrylic acid, 2-acrylamido-2-methylpropane sulfonic acid, itaconic acid, tertiary butyl acrylamide, acrylamide, methacrylamide, and any combination thereof.

8. The method of claim 1, further comprising adding benzotriazole to the aqueous medium.

9. The method of claim 1, wherein the composition comprises from about 5% to about 50% by weight of the compound of formula (I) or salt thereof.

10. The method of claim 1, further comprising adding or generating in situ an oligomeric maleic acid or oligomeric maleic anhydride of formula (II) or oligomeric maleic anhydride of formula (III) to the aqueous medium, 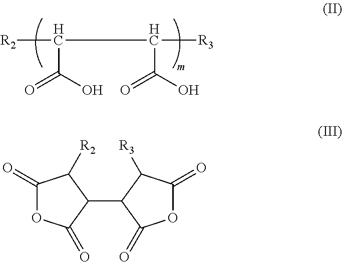
where m is 1, 2, 3, 4, 5, or 6; and
R₂ and R₃ are independently selected from the group consisting of hydrogen, substituted or unsubstituted C₁-C₁₀ alkyl, substituted or unsubstituted C₄-C₆ aryl, substituted or unsubstituted C₁-C₁₀ alkoxy, hydroxyl, cumene, meistylene, toluene, and xylene.

11. The method of claim 1, further comprising adding or generating in situ 1,2,3,4-butane tetracarboxylic acid or any salt thereof to the aqueous medium.

12. A composition, comprising:
a polymer and a compound of formula (I) or salt thereof, 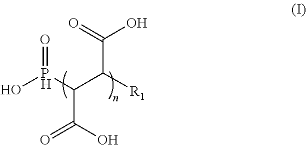
where R₁ is hydrogen, hydroxy, or a C₁-C₄ carboxyalkyl group; and
n is 1, 2, 3, 4, or 5.

13. The composition of claim 12, wherein R₁ is hydrogen.

14. The composition of claim 12, wherein n is 2, 3, or 4.

15. The composition of claim 12, wherein the compound of formula (I) or salt thereof is selected from: 2-(hydroxyhydrophosphoryl)succinic acid; 1-(hydroxyhydrophosphoryl)butane-1,2,3,4-tetracarboxylic acid; 1-(hydroxyhydrophosphoryl)hexane-1,2,3,4,5,6-hexacarboxylic acid; 1-(hydroxyhydrophosphoryl)octan-1,2,3,4,5,6,7,8-octacarboxylic acid; 1-hydroxy-4-(hydroxyhydrophosphoryl)butane-1,2,3,4-tetracarboxylic acid; sodium 3,4,5,6-tetracarboxy-2-(carboxymethyl)-6-(hydroxyhydrophosphoryl)hexanoate; and any combination thereof.

16. The composition of claim 12, wherein the compound of formula (I) or salt thereof is 1-(hydroxyhydrophosphoryl)butane-1,2,3,4-tetracarboxylic acid.

17. The composition of claim 12, further comprising benzotriazole and/or an additional corrosion inhibitor.

18. The composition of claim 12, further comprising an oligomeric maleic acid or oligomeric maleic anhydride of formula (II) or oligomeric maleic anhydride of formula (III) 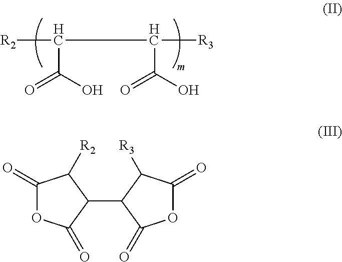
where n is 1, 2, 3, 4, 5, or 6; and
R₂ and R₃ are independently selected from the group consisting of hydrogen, C₁-C₁₀ alkyl, C₄-C₆ aryl, C₁-C₁₀ alkoxy, hydroxyl, cumene, meistylene, toluene, and xylene.

19. The composition of claim 12, wherein the composition comprises from about 5% to about 50% by weight of the compound of formula (I) or salt thereof.

20. A method of inhibiting scale, comprising:
adding the composition of claim 12 to an aqueous medium comprising a surface, and
inhibiting scale formation on the surface.
